(19) United States
(12) Patent Application Publication
(10) Pub. No.: US 2006/0026499 A1
(43) Pub. Date: Feb. 2, 2006

(54) Calendar based graphical user interface for manipulation of spatial operations and information

(76) Inventor: Corey Weddle, Ames, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/191,897

(22) Filed: Jul. 28, 2005

Related U.S. Application Data
(60) Provisional application No. 60/591,706, filed on Jul. 28, 2004.

(51) Int. Cl. G06F 17/24

(52) U.S. Cl. 715/503

(57) ABSTRACT

A computerized graphical user interface is provided for temporal manipulation of spatial operations and information. The interface comprising a general-purpose computer adapted for execution of instructions, wherein the instructions include a graphical user interface, and data for use by the general-purpose computer and adapted to be acted upon by the executable instructions, wherein the data comprises a representation of spatial operations and information. The interface displays with the graphical user interface a plurality of temporal cells, associates the spatial data with the temporal cells for display on the graphical user interface, and manipulates the spatial data through the temporal cells.

### RELATED APPLICATIONS

Priority is hereby claimed to U.S. Provisional Patent No. 60/591,706 filed on Jul. 28, 2004, and is incorporated herein by reference hereto.

### BACKGROUND OF THE INVENTION

1. Field of the Invention

The present invention relates to a computerized graphical user interface, and in particular to a graphical user interface for temporal manipulation of spatial operations and information.

2. Background

Agriculture, like most fields, has been technologically transformed in recent years. The field of precision agriculture is one such area of technological innovation that has produced far-reaching consequences and affects for modern agriculture. Advances in crop management, and in particular, the management of within-field variation creates enormous benefits and challenges for site-specific farming and crop management.

Presently, crop management decisions are typically made on a within-field basis. Entire fields are no longer treated as if they were one homogeneous unit. It has been understood for a long time that soil characteristics (pH, texture, organic matter) and other factors such as moisture conditions or weed problems may vary considerably within a given field. In the past it was not technologically feasible to account for such localized variations. This is no longer the case. Instead of managing an entire farm or field based upon some hypothetical average condition, which may not exist anywhere, a precision farming approach recognizes site-specific differences within fields and adjusts management actions accordingly. For example, based on extensive soil testing, different locations within a field may receive different amounts of fertilizer.

Technological advancements make precision farming not only possible, but make it easier. Smaller, faster, less expensive computers are of critical importance in gathering, analyzing, and acting upon information about soils and growing conditions in a timely manner. Soil sensors, variable rate applicators, on-the-go yield monitors, and global positioning systems (GPS) that use satellite technology to identify specific locations within fields are the high-tech tools of the precision farmer.

Harnessing this wealth of technology requires sophisticated data collection and analysis tools, of a type not considered practical or possible a few years ago. Accordingly, prior art methods of collection and analysis of crop management information are antiquated when it comes to meeting the demands of precision farming. Much improvement is required when it comes to managing the wealth of data available in modern farming in order to realize the true potential of precision agriculture.

In particular, data or events that are spatially orientated, for example related to a farm or field location, are collected or created for a wide variety of agricultural operations, and require a method for organization, viewing, and editing that conveys information efficiently and productively, and that are user friendly. Prior art systems for the conveying of such data or events utilize a system of data selection and interface based on the method upon which the data files were collected and stored—commonly called a file based approach. Some systems organize the data in a hierarchy that provides a management structure for information that can be selected for display, editing, and the like. The hierarchy can be organized according to some spatial hierarchy, for example by farm, fields within a farm, and so forth. Common GIS applications such as ESRI's ARCView software provide methods for selection of spatial information contained in a database and/or file system and layering this information together in a base hierarchy.

The problem with such prior art systems is that while they may provide a very linear, hierarchy driven approach to information selection and editing, this may not be the best way for the user to utilize or organize the information that they collect or create. Commonly, users activities or operations are very time sensitive and require planning and review that is temporally based, not hierarchy or file based.

Another problem is that many users currently manage and enter information of a spatial nature in static electronic or paper based forms, which provide no automated management, filtering, etc. of the information. Often users keep a printed-paper calendar and can add manual notes to track temporal events that occur spatially. These details are lost historically and spatially, and provide little to no interaction or usefulness for future planning activities or reviewing previous activities without extra effort and manual review of hand written information, which is not efficient or convenient.

Thus, a need exists for a novel approach to organizing and presenting spatial information to the user in a temporal manner that is productive, efficient, and user-friendly.

### SUMMARY OF THE INVENTION

An object of the present invention is to provide new and novel means for managing, viewing, and editing spatial information via a temporal-based graphical user interface.

These and other objects of the present invention will become apparent to those skilled in the art upon reference to the following specification, drawings, and claims.

The present invention intends to overcome the difficulties encountered heretofore. To that end, a computerized graphical user interface is provided for temporal manipulation of spatial operations and information. The interface comprising a general-purpose computer adapted for execution of instructions, wherein the instructions include a graphical user interface, and data for use by the general-purpose computer and adapted to be acted upon by the executable instructions, wherein the data comprises a representation of spatial operations and information. The interface displays with the graphical user interface a plurality of temporal cells, associates the spatial data with the temporal cells for display on the graphical user interface, and manipulates the spatial data through the temporal cells.

### BRIEF DESCRIPTION OF THE DRAWINGS

FIG. 1 is a screen shot of a graphical user interface, showing temporal and spatial information and operations.

FIG. 2 is a screen shot of a graphical user interface, showing temporal and spatial information and operations.

FIG. 3 is a screen shot of a temporal portion of the graphical user interface.

FIG. 4 is a screen shot of a data filter window of the graphical user interface.

FIG. 5 is a screen shot of a data grouping window of the graphical user interface.

FIG. 6 is a screen shot of a detailed event view window of the graphical user interface.

FIG. 7 is a screen shot of a summary data grouping window of the graphical user interface, showing a management item drop down list.

FIG. 8 is a screen shot of the summary data grouping window of the graphical user interface, showing a property item drop down list.

FIG. 9 is a screen shot of the graphical user interface in an alternative temporal view.

FIG. 10 is a screen shot of an edit associated event window of the graphical user interface.

FIG. 11 is a screen shot of a temporal day view of the graphical user interface, showing multiple events and a daily stat/info event thereof.

FIG. 12 is a screen shot of another temporal day view of the graphical user interface, showing another daily stat/info event and associated summary data.

FIG. 13 is a screen shot of a job editor window of the graphical user interface.

FIG. 14 is a screen shot of a task editor window of the graphical user interface.

FIG. 15 is a screen shot of a job view window of the graphical user interface.

FIG. 16 is a screen shot of a temporal view of the graphical user interface, showing a job and summary information relating thereto.

FIG. 17 is a screen shot of a job/task tree window of the graphical user interface.

### DETAILED DESCRIPTION OF THE INVENTION

In the Figures, is shown a graphical user interface for the display of spatially orientated data in a temporal calendar based management system. The system comprises a computer executable software package for use on a general purpose computer utilizing any conventional operating system such as Windows, Linux, or Apple based computer systems with a display screen that shows information in various functional windows and dialogs, a keyboard of a fixed or virtual nature, and a method for graphical selection on a display such as a mouse, stylus, touch pad, etc. Also required, is a database or file system to store information that can be retrieved by the interface mechanism and viewed, edited, and manipulated on the display.

In the preferred embodiment of the invention, the data is agricultural data. However, the invention is not so limited. Those of ordinary skill in the art will understand that the invention is generally available for use with all types of organized collections of computer hardware and software that utilize geographic data for the efficient capture, storage, updating, manipulation, analysis, and display of forms of geographically referenced information, for example geographic information systems (GIS).

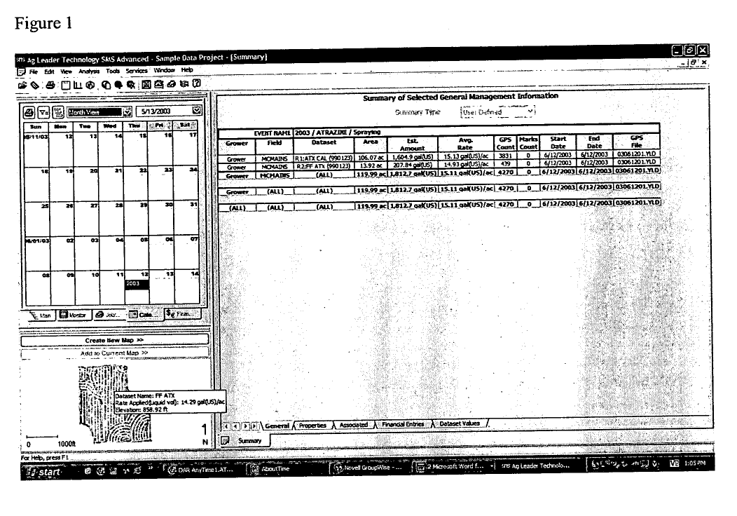

The system utilizes a graphical user interface (GUI) of the type shown in FIG. 1. The GUI generally is comprised of three segments: (1) a Gregorian style temporal calendar that can show information by Month, Week, or Day resolutions; (2) a spatial map showing details such as elevation, moisture levels, or yield in a graphical color coded format; and (3) an area for displaying summary information related to the events shown on the calendar and to the spatial map displayed.

In more detail, FIG. 1 shows a complete view of the GUI showing the calendar month view in the upper left portion of the screen shot, a spatial map preview in the lower left portion of the screen shot, and the summary information relating thereto in the right portion of the screen shot. The calendar is selected by selecting a calendar tab located below the calendar. In FIG. 1, the month calendar shows one month starting with Sep. 9, 2003. A temporal event is logged on May 13, 2003, and is highlighted for display. The event consists of an atrazine spraying of a particular spatial field or area, and is displayed in a dark color to indicate that it is the current selection. The spatial map is loaded and displayed in the preview map section, along with visual information about the orientation of the rows of the field. As shown in FIG. 1, moving the cursor or mouse over a section of the map displays additional information, in a tool tip box, associated with the specific location, such as, the name of the file containing the presently displayed information, the application rate, and the elevation. More particular data pertaining to this event is displayed in the summary area. This includes information displayed in several data fields, including, grower, spatial field, dataset (or the names of files containing the date), area of the field for each file, estimated amount of atrazine, average rate of application, GPS count, dates, and GPS file names. As described in greater detail below, the summary information displayed by default will vary depending on the nature of the event. Additionally, the summary information fields can be changed at any time to display any combination of different and additional information relating to the selected event. Summary values are provided as min/max, average, and total values. The event name is also displayed which indicates the calendar grouping that has been defined for the grouping of event information.

Furthermore, multiple calendar events can be selected, and the corresponding information displayed on the map and summary windows, including events that are on the same or different days. This, event-grouping option, can be accomplished by holding down the control key on the keyboard while making a selection. This preserves the prior selection and adds the current selection thereto.

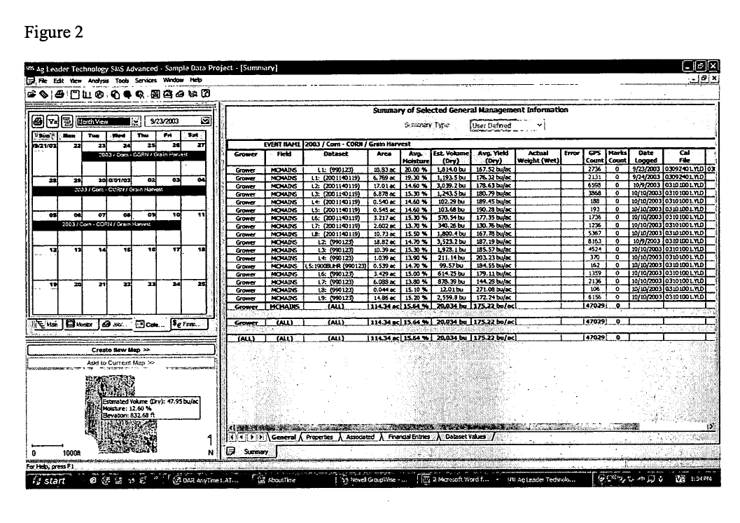

FIG. 2 is a second example of an application screen shot of the temporal display capability of the present invention. In this case, the date is set to Sep. 23, 2003. The highlighted event is a corn harvest. The calendar shows that the event lasted from September 23 until October 10. Again, the spatial map displays the fields associated with the grain harvest event, and the tool tip box displays yield, moisture, and elevation data on a point-by-point basis. The summary area displays detailed information associated with the event arranged by various categories. Again, the summary display categories are specific to the event and can be changed at any time.

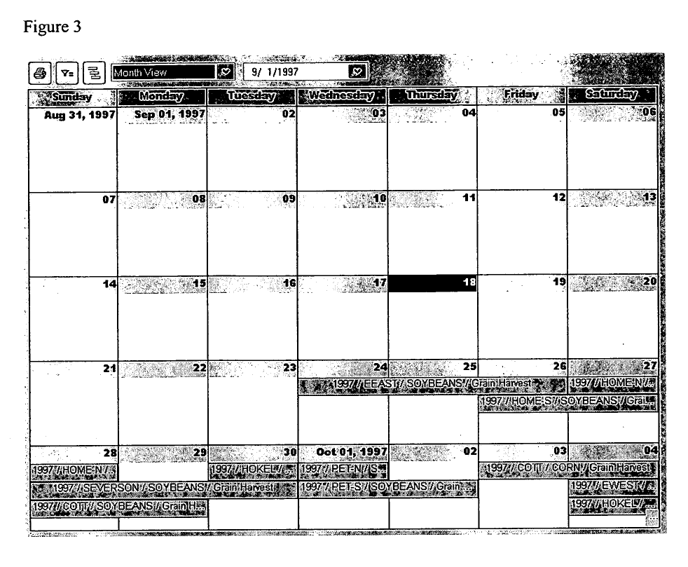

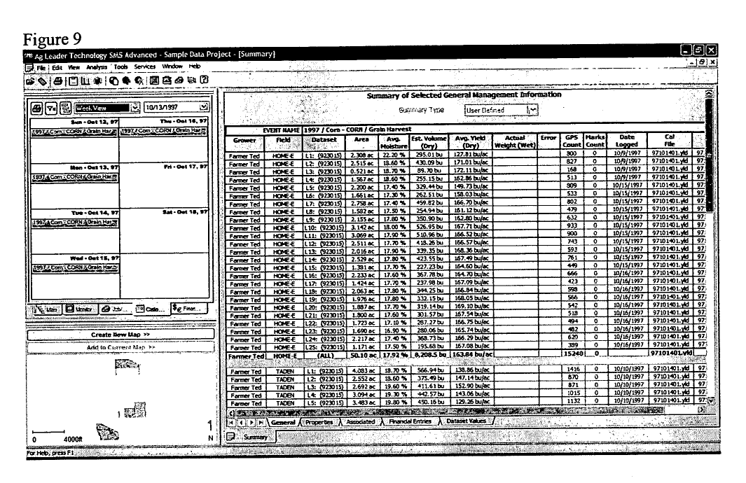

FIG. 3 shows in more detail the calendar interface. The display is currently set to the month view for a selected date span. Shaded bars shown on specific dates/calendar cells, or crossing multiple calendar cells, are events. The names shown on the events in this example show the calendar grouping that has been set for the display of events in the calendar. Different event types are available for display such as data file based events, as shown in FIG. 3, or associated event (such as notes reminders that the operator can manually enter and associated with particular dates). As is illustrated, multiple events can be displayed for a date in the calendar and when there are more events than can be displayed a different colored box with three dots in it will appear to indicate that additional events can be viewed for that date if you open the day view for the calendar. The calendar has three main temporal views: month; week; and day, and also features a print button to allow for printing a particular calendar view. FIG. 9 shows a screen shot of the week view of the calendar.

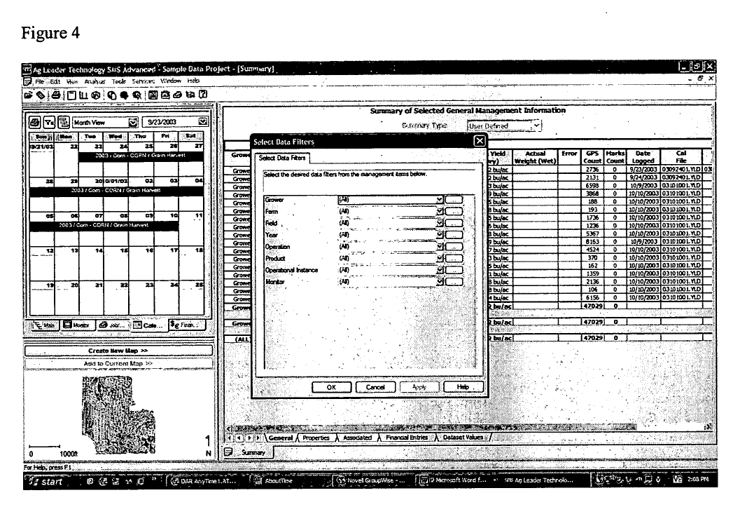

FIG. 4 shows a screen shot resulting from selecting the adjust calendar filter button located next to the printer button. Drop down menus allow the user to select from displayed categories which information they would like to display on the calendar. For example, if the system includes information from several farms or growers, the user can select which of these they want to view. If no selection is made all information is displayed.

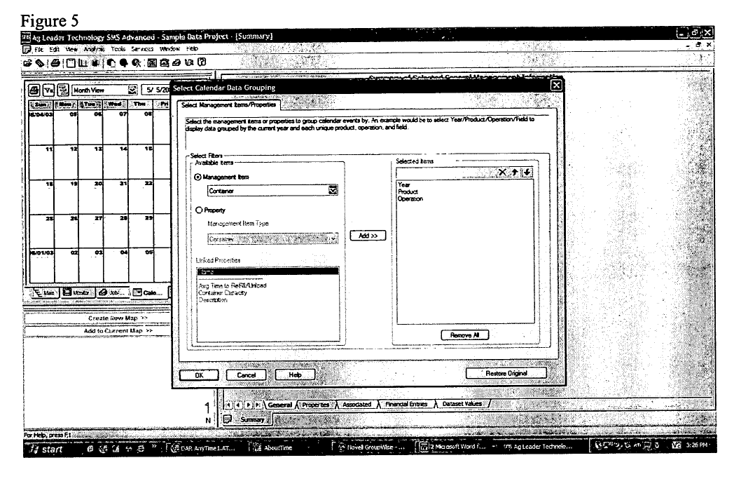

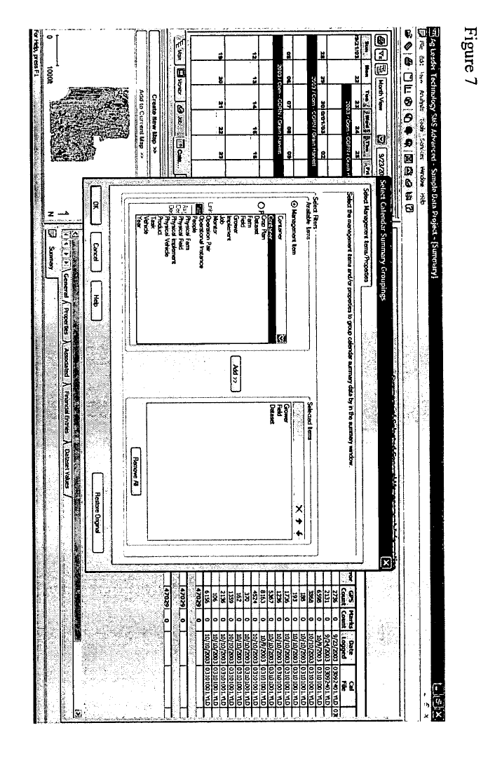

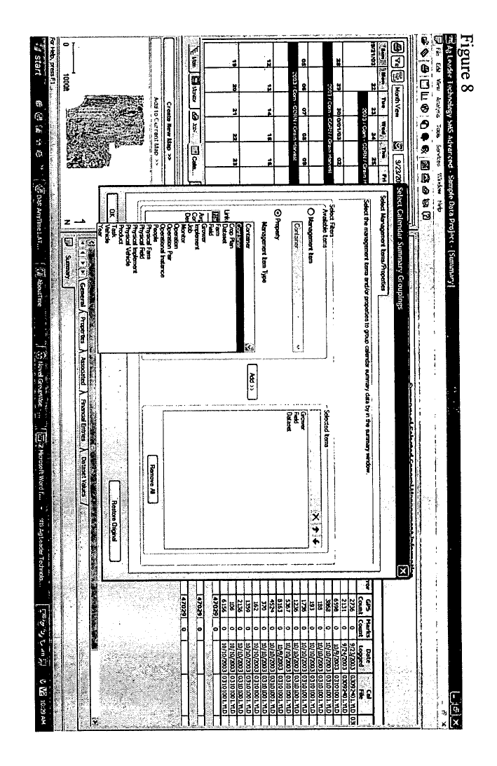

FIG. 5 shows a screen shot resulting from selecting the adjust calendar data grouping button located next to the adjust calendar filter button. This option allows the user to define how the event is displayed, or hierarchically grouped, when the event is displayed on the calendar. Calendar grouping allows the selection of grouping criteria from the management items or properties in the system. An example would be to set the grouping to display events in the calendar by Field, Product, and Operation. The selection criterion is the same as disclosed hereinbelow in reference to FIGS. 7-8. Another option for grouping management and property items comprises temporal grouping. The user can define a period of time, preferably a week, by selecting the first day of the week. Then the user can group display items by a week, or several weeks. In this manner the display can place together management and property items that fit logically within a predefined period of time, such as items relevant to a pay period for employees.

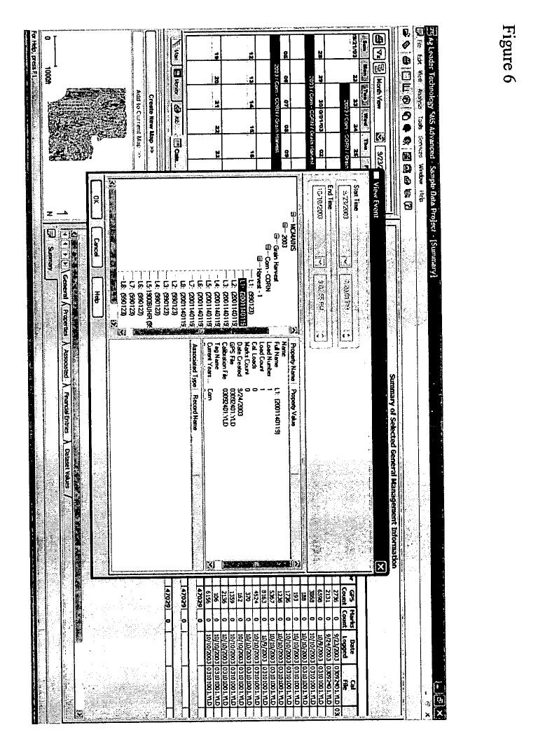

FIG. 6 shows a screen shot resulting from further selection of the event displayed on the calendar. This selection can be done by clicking the right mouse button while the cursor is on the calendar event, or double-clicking, with the mouse. The view event window displays in hierarchical fashion information about the event data files, which displays a tree with all the management items and datasets that are contained in the currently viewed event selection. The management items can be edited by selecting them from within the tree and clicking the right mouse button and selecting the edit option. Associated data items can be added at all levels of the tree if desired. If an individual file is selected from within a set of data files that comprise an event, further information about the selected data file is displayed in one of the two windows on the right of the event window. In the display shown in FIG. 5, the data file information is shown in the property area. Associated types, such as notes or reminders, would be displayed directly below.

FIGS. 7-8 show screen shots of a select calendar summary grouping. This window can be viewed by clicking the right mouse button while the cursor is on the summary area and selecting the edit calendar summary grouping. This allows the user to select the information displayed in the summary window. The selections come from two different types of items, management items (shown in FIG. 7), and property items (shown in FIG. 8). This gives the user a great deal of flexibility when it comes to viewing data fields in the summary window.

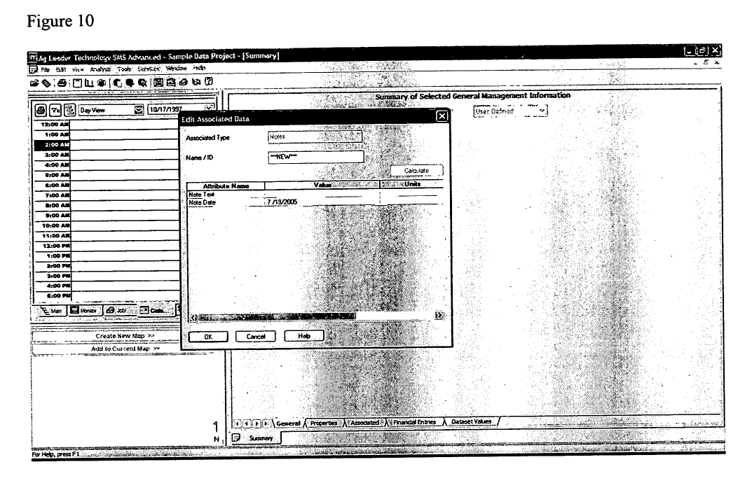

As mentioned previously, the system allows for the addition of associated data. FIG. 10 shows a screen shot of an associated data window that allows for the entry of user defined associated events, like reminders, notes, or to-do items. FIG. 10 also shows the calendar in the day view mode. These associated events are different in that they do not have to have a data file associated therewith. This is accomplished by selecting the day calendar view, then selecting a particular time by clicking the right mouse button, or double-clicking, while the cursor is on the time slot. A window opens that asks the user to select the associated data type from a drop down menu of options. A note/reminder comprises the most common type of associated data. Once the type is selected the associated events window shown in FIG. 10 appears allowing the user to enter an event. Once the event is entered, it appears on the calendar, and if selected more particular information appears in the summary window. This feature is especially useful in that it allows the user to schedule temporally upcoming events, and allows for the storage and display of such events in the same system that tracks all of the users historical events. Furthermore, reminders and notes can be spatially linked, for example to datasets that represent a particular field or portion of a field.

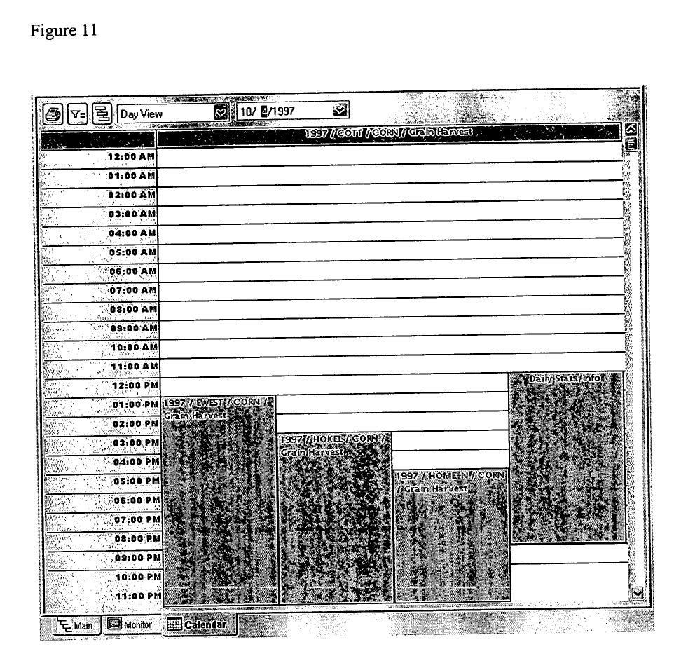

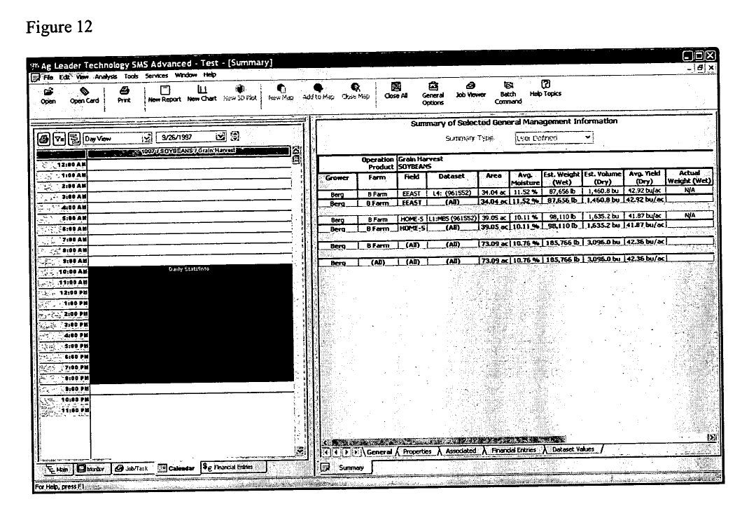

The day view display for the calendar can also include a daily stats/info event that appears on the calendar as a temporal event, and displays summary information specifically for the current day only in the summary window when the calendar event is selected (see FIG. 11-12). Also, the stats/info event can be associated with events that span more than one day. The summary window will display all of the information for the event and not just the data for the currently selected day.

The system provides additional features and options as well, including:

Month/Week/Day View Type Selection—allows the selection of the view type for the calendar, month views shows 35 days at a time, week view shows 7 days at a time, and day view which shows events for a day from 12 am to 12 pm.

Date Selection—allows the selection of a date to display events for, before, or after.

Calendar Menu—accessible by clicking the right mouse button on the calendar, includes:
Add Event—adds a manual event, such as a text note or reminder.
View/Edit Event—displays the detailed view of an event, such as the datasets it covers, the time span it covers, etc.
Delete Event—deletes a manual event.
Move Event—moves manual event to a new location on the calendar.
Adjust Event Start—adjusts the start date of a manual event.
Adjust Event End—adjusts the end date of a manual event.

As described hereinabove the calendar includes several options and features. General user instructions for these options are as follows:

1. The calendar is viewed by selecting the calendar view tab in the main window.

2. The area above the calendar displays the available tools for working with the calendar. The current date should be displayed in a selection in the upper right corner of the window.

3. The user can adjust the date to a time of a logged event, such as the month and year of harvest with a yield monitor and GPS receiver. The date can be changed by selecting the date with the mouse and either typing in a number or using the arrow keys on the keyboard to increment the values. Additionally, the user can select the down arrow beside the date values and a small calendar will appear that the user can use to select a new date.

4. Once the user selects a date range with spatial data in it, they will see a gray bar(s) with a year/product/operation based name. These bars are called calendar events and are based on a grouping filter that can be set to group data into events of the user's choosing as disclosed above.

5. Left clicking on one of the gray boxes, selects the event and it turns to a dark color to indicate it is selected. The Summary Window will update with a summary of the selected calendar event. This summary view is different than other summaries in that it lists different management items together and provides a total of the relevant entries at the bottom. The summary can also be printed.

6. In addition to the Summary, displaying the spatial map will display all the data for the selected calendar event, which can be mapped. For example, the map can show spatially all soybean or corn harvest data for the selected event or events, with one button press.

7. The user can change the resolution of the calendar between a month, week, and day views for better resolution of the calendar view. In the day view, a daily stats/info is also available that summarizes the data that was collected on that day, but no map will be displayed.

8. Two filter and grouping buttons are available above the calendar view:
a. The first filter is a standard Data Filter that limits the data that can be viewed in the calendar, such as only displaying data from a certain Grower or an Operation.
b. The second button is for selecting the calendar event grouping. This allows the user to organize how the calendar will group the data it displays. For example, the user could set the grouping to display events by Operator, Field, and Product or Vehicle, Field, and Operation. The management items that are in the system limit the calendar grouping and the properties associated with those management items.

9. A print button is also provided in the Calendar View that will print the current calendar that is displayed, and in the format that it is displayed.

10. Notes can also be added to a date on the calendar by selecting a day in the calendar, which should then highlight at the top in blue, click the right mouse button, and select the add event function. This will allow the user to add text notes that will only be available in the calendar, but provides yet another way for you to document your operational activities.

11. Lastly, the user can select to view more detailed information on a calendar event by double-clicking with the left mouse button on a calendar event bar or by clicking your right mouse button with a bar selected and selecting view/edit event from the menu that appears. This will bring up the view event dialog, which will display a tree of all the management items and datasets that make up the selected event. Most management items can even be edited from this view, except for Farm and Field.

The system uses the following protocol to generate calendar events. In the preferred embodiment the code is written in C⁺⁺, other suitable or similar programming languages can be used. All the calendar events contain a start date, an end date, and an event type. The current list of event types has the following definition:

enum EventTypes

{

DatasetEvent = 0,
UserAssocDataEvent = 1,
FileInfoEvent = 2,
FileGroupEvent = 3,
DatasetDayEvent = 4,
// not stored in the database, but generated from combining
other events
LogicalJobEvent =997, // these are just generated dynamically
LogDatasetsDayEvent = 998,
DatasetsBlockEvent = 999,

MultiDayEvent = 1000

};

MultiDay event is built dynamically from multiple selected dates in the calendar and is a merging of all DatasetDayEvents for each of the selected day events.

The DatasetEvent and DatasetDayEvent are generated automatically from the timestamp attribute (provided it is available) whenever a dataset is saved (whether it be through the spp, import, or whatever else). The difference between the two is that the start and end dates for the DatasetEvent are the earliest and latest sample timestamp from a “load”, but there may be multiple DatasetDayEvents for a load, if the data was collected over multiple days in this case the start and end dates will be the earliest and latest sample timestamp within each day for the “load”. Note also that there is special “accumulating” of the spatial summary to include totals/averages for each day for a load (when the timestamp attribute is available) in addition to the normal spatial summary for the entire load, which are used specifically for the purpose of the calendar.

The FileInfo event is also generated when reading files from the preprocessor, and it is just the event of when a file was read, and is linked to the info in the file history table. UserAssocDataEvent is linked to “associated data” that you manually add such as notes/reminders. These events all have corresponding records in the “calendar event table” in the database.

The ALD_CalendarManager generates the other event types dynamically when data is requested for the calendar window.

FileGroup—is made up by combining all the file information for events that occur on the same day.

Datasets Block—is made from combining dataset events from datasets that are of similar content (defined by grouping criteria) (i.e. all soybean harvest datasets from a farm may be grouped together).

LogDatasetsDayEvent—is made from combining dataset day events from the same day.

JobsEvent—is made from the data in the job table.

A further embodiment of the invention comprises the ability to created jobs and tasks. The organization of the system allows for forward-looking operational planning through the use of two types of user-initiated activities—jobs and tasks. A job is defined as a grouping of one or more tasks that user plans to perform during a certain time span. A task is defined as one or more operations that are planned to occur in a specific spatial location, and will be associated with actual/logged data upon the occurrence of the operation or event spatially.

The purpose of jobs and tasks is to provide planning and tracking of operations that will occur during the crop production cycle. An example would be planning of spring planting for an entire farm(s). The user would first write all the planting prescriptions for all the fields that will be planted, then create a job called “Spring 2006 Planting” and then add tasks for each field the user created a prescription for. The tasks are all associated with the Job—Spring 2006 Planting.

The user now has a record of the plan for Spring 2006 planting, and if the user logs as-applied data with a monitor system and reads the data into the system, the actual data will link up with the planned data and can be viewed in a summary so that user can compare planned versus actual results. Using jobs, the user can also export all the assigned tasks at one time to the field device. Thus, if the user assigned 50 tasks (fields) to a job all the prescriptions, boundaries, and setup information is transferred all in one simple process.

Jobs and tasks are also shown in the calendar view. The planned time span of the job will be displayed and when the job event is selected in the calendar, a summary is displayed that list all the tasks that are assigned to the job and various properties of those tasks. The actual data that is logged and related to the job and task will also be displayed in the calendar as its own event, based on the grouping and filtering that was selected for the calendar view. This allows for viewing what was planned for the job versus the actual results of the operations represented by the job.

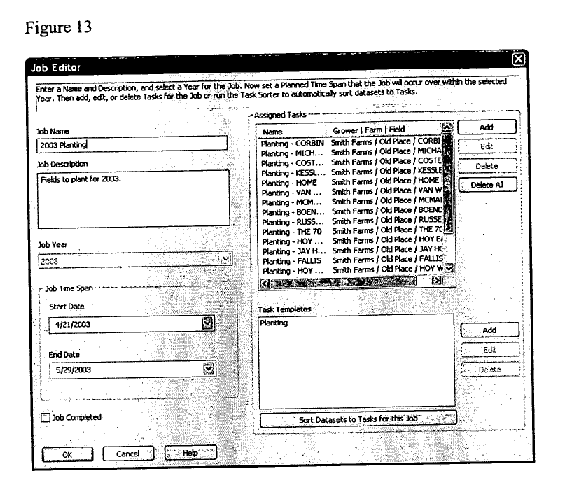

FIG. 13 shows a screen shot of a job editor used to create a job. The user can enter a name, description, and define the time span for the job. Further, the user can assign tasks to the job, as described hereinbelow. Task templates can be added. The templates contain datasets that are associated with the job. The templates include one or more operational pairs, which are explained in detail hereinbelow. The templates also include instructions on how to sort the datasets, for example by year, grower, farm, ect.

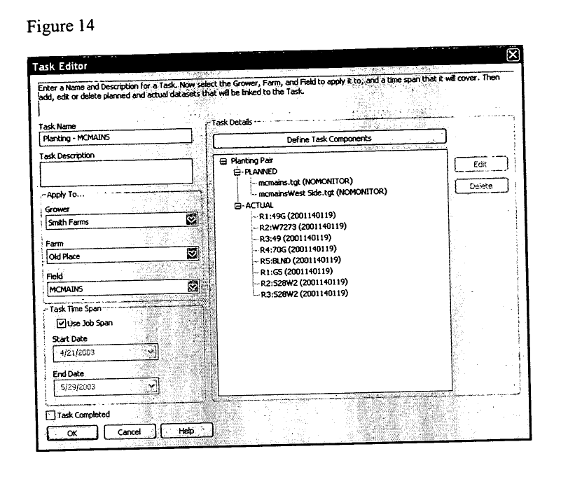

FIG. 14 shows a screen shot of a task editor used to create tasks. The user can enter a name, description, and define the time span for the job (if different from the time span for the job which the task will be associated with). The user must define the grower, farm, and field for each task. A task can only be assigned to a single grower/farm/field combination. A task details window displays the operational pairs to be associated with the task. The operational pairs can be predefined or defined by the user. Operational pairs can be selected and/or defined by selecting the define task components bar. Operational pairs are the operative link between the planned and actual versions of an operation that the user wants to perform in a field. Operational pairs are further associated with datasets that define the spatial scope of the operational pairs. An example of an operational pair would be a planting prescription and a planting operation to be carried out with the defined prescription. These operations relate to the same activity in the field, but they differ in that one is a plan (i.e. the prescription rates), and the other is what will actually happen (i.e. the as-applied data). The user needs a way to link these operations together, which is the function of the operational pair. Furthermore, the user needs to associate the operational pair with specific spatial information to identify area or map where the operation will take place.

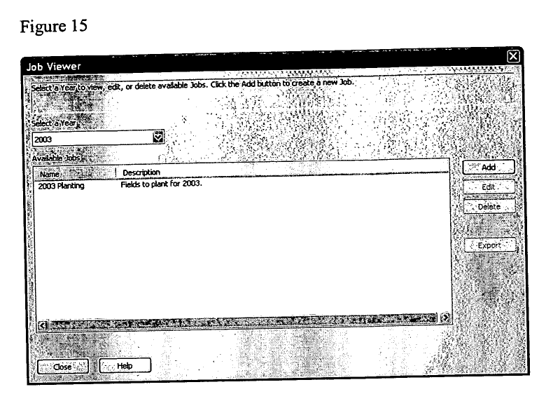

FIG. 15 shows a screen shot of a job viewer, which allows the user to view jobs or to initiate new jobs. The latter operation simply activates the job editor described hereinabove.

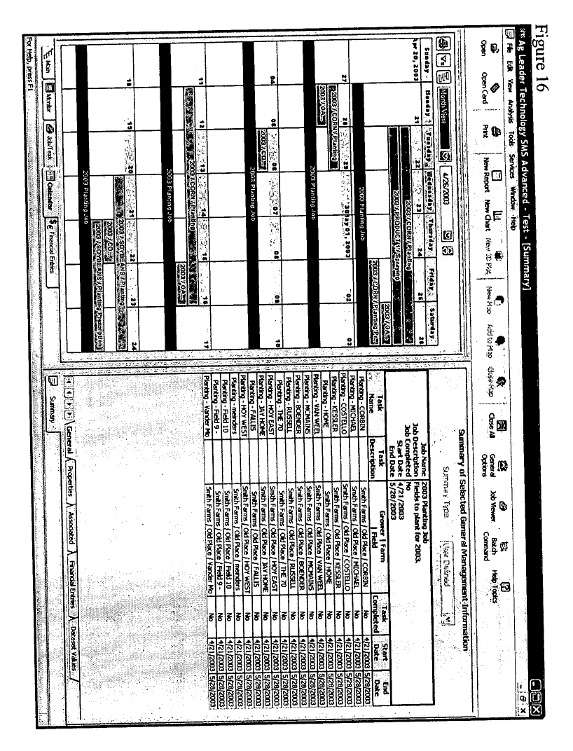

FIG. 16 shows a screen shot of a temporal display of a job along with the actual activity displayed in a calendar format. The summary window displays summary information for the selected job.

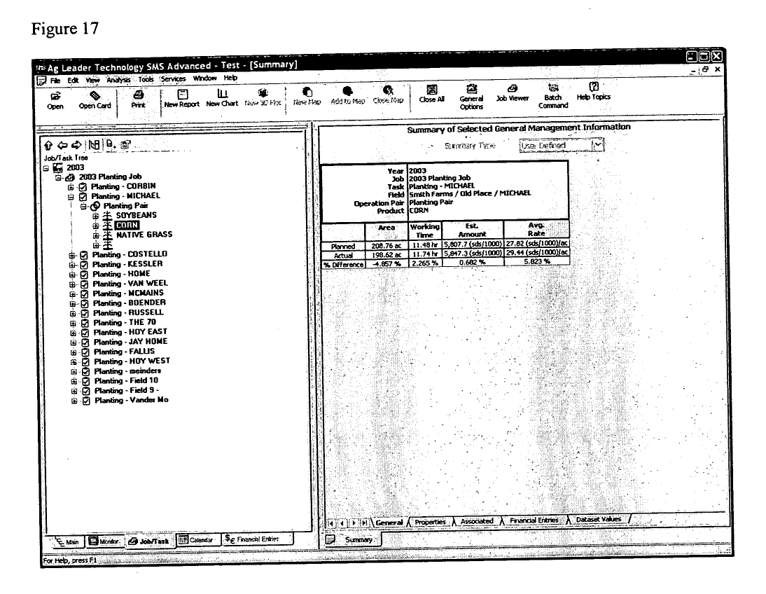

FIG. 17 shows a screen shot of a job/task tree display. This window displays a job and its constituent tasks in a hierarchical tree format, along with summary information that corresponds to the highlighted potion of the tree.

Based on the foregoing, the present invention substantially eliminates the problems associated with the prior art, and presents a number of advantages and advancements thereof.

The calendar display can be filtered to show only specific information from the database or file system for a selected event. It can also be setup to group selected information from two categories of information—management items or properties. Organized in this manner, the system displays the GUI in many different ways.

Selection of events in the calendar-based GUI can load the spatial data from the attached database or file system for visualization of the information, selection, or the data can be directly mapped to a mapping window for display and editing of spatial information. Selected events in the calendar can also display a tabular summary of information defined by the event, such as averages, minimums/maximums, and totals for an event.

Metadata contained in an event in the calendar can also be edited as appropriate for the type of spatial information it contains. Manually entered notes can also be added to the calendar and defined with event spans for display on the calendar and storage in the database or file system.

The calendar-based GUI can also be used as a planning tool. Planning can occur in several forms:

Appointments for spatial operations that are booked in advance. An example would be to plan to apply a certain chemical to a customer's field or to repair a gas line at a specific spatial location.

Preplan work to occur in a spatial area. For example, generate a prescription for a certain application rate in a spatial area and then define a time span, thus event, for when this application should occur.

Events can automatically be generated based on criteria linked to the occurrence of a spatial operation. For example if you scouted a crop for pests then an event to re-scout that crop 3 weeks from the last event occurrence would be added to the system and displayed on the calendar interface as a reminder that a spatial activity needed to occur on a certain date or with a certain time span.

The planning examples listed above could then also take the form of providing a warning/reminder to the user in various forms, such as popping up a message on the users screen to announce a planned event that needs to be executed that is approaching, time and date wise. Such a warning could also be broadcast via the internet to Microsoft SPOT enabled devices, through cellular networks, or other wired or wireless transmission methods to an electronic device that can display the reminder of an impending spatial operation that has been planned.

Additional information and editing could occur via the calendar-based GUI other than just the editing of metadata discussed in examples of this embodiment. Examples of additional editing could include setting resource tracking information, entering expense/income values that correspond to events, etc.

Spatial data management and integration is another key aspect of what is claimed in this embodiment, specifically in how data is managed and updated. When information is created or processed into the system, DatasetEvents and DatasetDayEvents are generated based on the temporal data contained in information being processed or that is manually defined by a user when inputting data into the database or file system that does not contain temporal data. Similar events are created for notes that are added. Any information being processed into the system gets a calendar event created for it that tracks the temporal aspects and relationships of information read into the database or file system. Event tracking for input and output files can also be created and managed or displayed. Events are also created for jobs/tasks items, based on the defined operating span of each and displayed in the calendar GUI to indicate what jobs/tasks are planned for a spatial region(s) for a temporal span.

Another part of the management aspect of the calendar interface is that as new information is processed over time that relates to a temporal event in the calendar, the system will verify links to related data via metadata information and temporal spans to add new information automatically to an event to provide an updated map or summary display that includes the new information for the event, automatically without user intervention.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention. For example, the temporal and spatial data, information, and events utilized by the graphical user interface can be exported or imported to and from multiple computing devices, such as mobile devices or handheld computing devices. The system provides for export and import operations to synchronize multiple computing devices.

1. A computerized graphical user interface for temporal manipulation of spatial operations and information, said interface comprising:
providing a general-purpose computer adapted for execution of instructions, wherein said instructions include a graphical user interface;
providing data for use by said general-purpose computer and adapted to be acted upon by said executable instructions, wherein said data comprises a representation of spatial operations and information;
displaying with said graphical user interface a plurality of temporal cells;
associating said spatial data with said temporal cells for display on said graphical user interface; and
manipulating said spatial data through said temporal cells.

2. The interface in accordance with claim 1 further comprising the step of displaying spatially with said graphical user interface said spatial data associated with said temporal cells.

3. The interface in accordance with claim 1 further comprising the step of displaying with said graphical user interface said operations and information as represented by said data associated with said temporal cells.

4. The interface in accordance with claim 1 further comprising the step of grouping said spatial data wherein said groups include one or more events associated with said operations and information.

5. The interface in accordance with claim 4 wherein said groups span a plurality of temporal cells.

6. The interface in accordance with claim 1 wherein said operations and information are agricultural events.

7. The interface in accordance with claim 1 wherein said temporal cells are units of a Gregorian calendar.

8. The interface in accordance with claim 1 wherein said spatial data is a representation of one or more units of agricultural land.

9. The interface in accordance with claim 1 further comprising the step of associating associated events with said temporal cells, and displaying said associated events with said graphical user interface.

10. The interface in accordance with claim 9 wherein said associated events are linked to said spatial data.

11. The interface in accordance with claim 1 further comprising the step of associating management and property items with said spatial data and said temporal cells.

12. The interface in accordance with claim 11 further comprising the step of grouping said spatial data wherein said groups include one or more events associated with said operations and information, and are hierarchically associated with said management and property items.

13. The interface in accordance with claim 1 further comprising the step of creating a job comprised of one or more tasks, wherein said task comprise spatial operations or information planned to take place.

14. The interface in accordance with claim 13 wherein said task further comprises operational pairs comprised of planned and actual operations or information linked to datasets that define a spatial scope of said operational pairs.

15. The interface in accordance with claim 1 providing a plurality of computing devices adapted for execution of instructions, wherein said instructions include a graphical user interface, and for manipulation of said spatial data through said temporal cells.

16. The interface in accordance with claim 15 comprising the step of synchronizing said plurality of computing devices through data import and export operations.
